(19) United States
(12) Patent Application Publication
(10) Pub. No.: US 2026/0151869 A1
(43) Pub. Date: Jun. 4, 2026

(54) METHOD FOR OPERATING A MACHINE TOOL

(71) Applicant: DMG MORI Pfronten GmbH, Pfronten (DE)

(72) Inventor: Rolf KETTEMER, Marktoberdorf (DE)

(73) Assignee: DMG MORI Pfronten GmbH, Pfronten (DE)

(21) Appl. No.: 19/122,730

(22) PCT Filed: Oct. 12, 2023
(86) PCT No.: PCT/EP2023/078302

§ 371 Date: Apr. 19, 2025

(30) Foreign Application Priority Data
Oct. 25, 2022 (DE) 10 2022 128 237.6

(51) Int. Cl. B23Q 11/12; B23Q 3/155

(52) U.S. Cl. CPC B23Q 11/126; B23Q 3/15503

(57) ABSTRACT

A method for operating a machine tool equipped with a pump for delivering a cooling lubricant includes inserting a tool into a work spindle of the machine tool and performing a teaching process. The teaching process involves determining a pump characteristic associated with the tool, identifying an optimum operating point of the pump for the tool, and storing the optimum operating point in a tool table.

### CROSS REFERENCE TO RELATED APPLICATIONS

This application is a National Phase of, and claims priority to, International Application Number PCT/EP2023/078302, filed Oct. 12, 2023, which claims priority to German patent application 10 2022 128 237.6 dated Oct. 25, 2022, the entire disclosures of each of which are incorporated herein by reference.

### TECHNICAL FIELD

The present disclosure relates to a method for operating a machine tool and to a machine tool. In particular, an energy consumption of the machine tool is to be reduced by determining an optimum operating point of a pump for delivering a cooling lubricant.

### BACKGROUND

Mixed friction, which can occur during the machining of a workpiece with a tool in a machine tool, is a common challenge in such processes. Cooling lubricants (CSS) reduce the friction and can thereby reduce the wear of the tool, the heating of the workpiece and the energy requirement. CSS are used to cool the tool or the workpiece and to reduce friction between the tool and the workpiece. Furthermore, in some machining processes. CSS can also help remove chips from the working environment, improve the dimensional accuracy of the workpiece, and enhance its surface quality. In addition, the workpiece can be protected from corrosion. Conventional CSS can also contain additives in addition to water and oil.

In the prior art, it is conventional to provide the CSS by means of a speed-controlled pump with a high predefined pressure of, for example, 50 to 100 bar, so that a sufficiently high volume flow is maintained at all times. However, it has been found that a significantly lower pressure is often adequate to provide effective cooling for the tool. As a result, the energy consumption of the pump can be significantly reduced. Furthermore, it has been found that the surface quality of the workpiece can be improved at low pressure. Furthermore, the service life of the tool can be increased during operation at lower pressure.

The article B. Denkena et al. “Energy efficient machine tools”, CIRP Annals-Manufacturing Technology 69 (2020) 646-667 provides an overview of technologies for reducing an energy consumption of machine tools. In this case, it has been shown in particular that the process cooling has a large energy saving potential. If, for example, the system properties of a machine tool with a speed-controlled high-pressure pump are considered, small changes in the cooling lubricant throughput have a significant influence on the electrical pump power without influencing the tool wear in the case of a specific set of cutting parameters.

Although a large amount of energy can be saved by changing a pressure control of the pump for delivering the CSS to a volume control, this measure has not hitherto been used in industry. One reason for this is the lack of knowledge about the exact volume flow to operate a specific tool or machining process. A further reason can be the absence of a suitable flow sensor for measuring the volume flow of the CSS.

### SUMMARY

The present disclosure is based on the object of overcoming the problems known in the prior art and of specifying a method for operating a machine tool which is improved in relation to the prior art and of providing an improved machine tool. In particular, an energy consumption of the machine tool is to be reduced as a result.

A further object of the disclosure is to improve a surface quality of the workpiece after machining with a machine tool. Furthermore, a service life of a tool is to be increased.

The object is achieved according to a method for operating a machine tool according to an independent claim, a method for operating a machine tool according to another independent claim, and by a machine tool according to another independent claim. Examples of the present disclosure are defined in the dependent claims, the appended drawings and the following description of examples.

The method described in this disclosure can be implemented in almost any existing numerically controlled machine tool, such as a CNC machine, for machining a workpiece with a tool. Such a machine tool generally has a work spindle into which a tool such as for example a drilling/milling head or the like is clamped.

The machine tool also has a pump for delivering a cooling lubricant (CSS) for cooling the tool or the workpiece. The pump can be, in particular, a speed-controlled high-pressure pump. Furthermore, the machine tool can have a flow sensor for measuring a volume flow of the CSS.

In a first step of the method, a tool is inserted into the work spindle of the machine tool. The tool can be removed, for example, from a tool magazine or the like, wherein this process preferably takes place automatically.

According to one aspect of the disclosure, a teaching process is performed in which a pump characteristic specific to the tool is determined. The pump characteristic can describe, for example, a dependence between a power consumption and/or a speed of the pump and a volume flow of the cooling lubricant through the tool.

The profile of the pump characteristic can be dependent on a plurality of parameters. In particular, the geometry of the tool influences the pump characteristic. It is generally very complicated to determine the pump characteristic in advance, for example by simulation or numerical calculation. It is therefore advantageous to determine the pump characteristic empirically via the teaching process.

The power consumption of the pump in watts can be determined, for example, depending on a pump speed and/or a pump current. The value of the power consumption (in watts) and/or the speed (in l/s) and/or the pump current (in amperes) can be detected, in particular, by a pump controller. The power consumption, pump speed, or pump current may collectively be referred to as performance characteristics or parameters.

An optimum operating point of the pump for the tool can then be determined. The operating point is, in particular, a point on the pump characteristic. The optimum operating point is distinguished, in particular, in that sufficient cooling of the tool is ensured here, while the energy consumption can be minimized.

According to one example, a plurality of different optimum operating points can be determined on the basis of different criteria, for example minimized energy consumption, sufficient cooling power, maximum service life of the tool, improved surface quality of the workpiece and the like. There is also the possibility of defining an average value of these criteria as the optimum operating point.

In a further step of the method, the optimum operating point of the tool is stored in a tool table. During subsequent machining of a workpiece with the same tool or a structurally identical or similar tool, the optimum operating point can be read out from the tool table and set. In particular, other machine tools can also access the tool table and set the optimum operating points during machining of workpieces.

For example, the tool table can be provided via a server or a cloud to a plurality of machine tools which can be located at geographically remote locations. For this purpose, the machine tools can be connected to a network via suitable interfaces.

An optimum operating point can therefore be determined for each tool or tool type. During subsequent machining of workpieces, renewed learning is no longer necessary. The optimum operating point can then simply be read out from the tool table and set.

The optimum operating point may specify parameters such as pump speed, pump power, or pump current. A machine tool without a flow sensor can still be operated at the optimum operating point. A controller, in particular a pump controller of any suitable machine tool, can be designed for operation with optimum operating points, for example by means of a software update, with the result that the method according to the disclosure can be easily retrofitted on existing machines.

The teaching process may include detecting a performance characteristic of the pump, such as power consumption, pump speed, or pump current. The performance characteristic can be measured, for example, or output by a pump controller.

Furthermore, the teaching process can comprise a step for detecting a volume flow of the cooling lubricant through the tool. For this purpose, the machine tool can have a suitable flow sensor or volume flow sensor.

According to another example, the teaching process can be performed during idling of the machine tool, that is without machining a workpiece. In this case, the teaching process is a separate process which, however, has to be performed once for each tool. The teaching process does not need to be repeated for each machine tool. A machine tool which has a volume flow sensor can therefore be used in particular for the teaching process.

In order to record the pump characteristic, the pump can be operated in the teaching process at a plurality of different performance characteristics or pressure settings and/or pump speeds and/or power values. A typical pressure of the CSS provided by the pump can be 40 to 100 bar, preferably 50 to 80 bar.

According to a further example, the teaching process can be performed using data detected during machining of a workpiece or during a plurality of machining operations. For this purpose, for example, during machining of one or a plurality of workpieces by a machine tool or a plurality of machine tools, the parameters of the pump (performance characteristic) and a measured volume flow of the CSS and the tool used can be detected and stored. An evaluation can then be performed for each tool or for each type of tool in order to produce a pump characteristic for each tool or for each type of tool.

A teaching process described above can be performed, for example, on the basis of a plurality of centrally collected and stored operating data of a plurality of machine tools, so that a corresponding tool table can be produced centrally. As soon as an optimum operating point for a tool used is available, this can then be used during subsequent machining. The centrally produced tool table can, in particular, be made accessible to all machine tools in a group on a central data storage device, so that the determined optimum operating points can be called up. The corresponding optimum operating point can therefore be read out and set each time a tool change is performed. The reading-out step can also be performed in advance for each tool used during machining of a workpiece. In the case of machine tools which cannot automatically access the tool table, the respective optimum operating point can also be set manually by a user of the machine tool.

The optimum operating point may be determined based on the type and size of the tool. Correspondingly, the optimum operating point can be stored together with the tool type and size in the tool table. It can thus be specified, for example, that this is an optimum operating point for an M5 drill. Further exemplary types of tools comprise (turning) chisels, milling tools, planers, rasps, grinding tools which can be present in a multiplicity of sizes and/or geometries. Furthermore, these can be left-handed or right-handed tools.

Each tool may have a unique identification in a tool deposit or in a tool magazine. The optimum operating point can thus be stored together with the identification in the tool table. Modern machine tools can generally perform an automatic tool change. During this change, the optimum operating point can then be set in each case from the tool table.

In addition, the optimum operating point can be dependent on the material of the machined workpiece. Correspondingly, the optimum operating point can be determined depending on the material. For example, a hard material may necessitate a higher cooling power and therefore a higher volume flow of the CSS than a soft material. The optimum operating points for different materials can likewise be stored in the tool table. A multiplicity of optimum operating points for a corresponding multiplicity of materials can therefore be present for a specific tool.

Furthermore, the optimum operating point can also be dependent on the machining process. For example, the desired or suitable cooling power can be dependent on a speed of the work spindle. The optimum operating point can preferably be determined and stored correspondingly in each case for different machining parameters and/or parameter ranges.

The optimum operating point may be determined using an algorithm. The algorithm can be executed in particular by a control device of the machine tool and/or on a central data processing device such as, for example, a server or a cloud.

A preferred method for machining a workpiece with a machine tool with a pump for delivering a cooling lubricant uses a previously determined optimum operating point. The method comprises a step for inserting a tool into a work spindle of the machine tool, a step for detecting an optimum operating point of the pump depending on the inserted tool or depending on the inserted tool and a material of the workpiece, and a step for machining the workpiece, wherein the pump is operated at the optimum operating point.

The step for detecting the optimum operating point of the pump can comprise, for example, a look-up of the optimum operating point in the tool table. The tool table can be stored locally in the machine tool. Alternatively or additionally, the machine tool can access a centrally stored tool table (for example on a server or in a cloud) via a network.

Such a machining method can be performed on a machine tool without a volume flow sensor, since the previously determined optimum operating point of the pump for the respectively used tool is read out and set. Since tools of the same type and of the same size have a similar geometry, an optimum operating point previously determined for this tool can be applied universally to any machine tool.

A preferred machine tool for machining a workpiece comprises a work spindle for receiving a tool for machining the workpiece, a pump for delivering a cooling lubricant for cooling the tool, and a control device for controlling the machine tool. According to the disclosure, the control device is configured to carry out a method according to the disclosure described above.

### BRIEF DESCRIPTION OF DRAWINGS

Further examples are described in more detail below on the basis of an exemplary system which is illustrated in the drawings but to which the disclosure is not restricted.

FIG. 1 shows a measured pump characteristic curve for a milling tool with a diameter of 6 mm (R0.8).

FIG. 2 shows a measured pump characteristic curve for a milling tool with a diameter of 3 mm (F0.2).

FIG. 3 shows a measured pump characteristic curve for a drill with a diameter of 2.5 mm.

FIG. 4 shows a measured pump characteristic curve for a drill with a diameter of 8.9 mm.

FIG. 5 shows a measured pump characteristic curve for a drill with a diameter of 14 mm.

FIG. 6 shows a comparison of measured pump characteristic curves for different tools. This figure originates from the article B. Denkena et al. “Energy efficient machine tools”, CIRP Annals—Manufacturing Technology 69 (2020) 646-667.

FIG. 7 shows a teaching process for different tools.

FIG. 8 shows a teaching process for different tools.

FIG. 9 shows an algorithm for determining an optimum operating point for a tool.

### DESCRIPTION

In the following description of an example of the present disclosure, identical reference signs denote identical or comparable components.

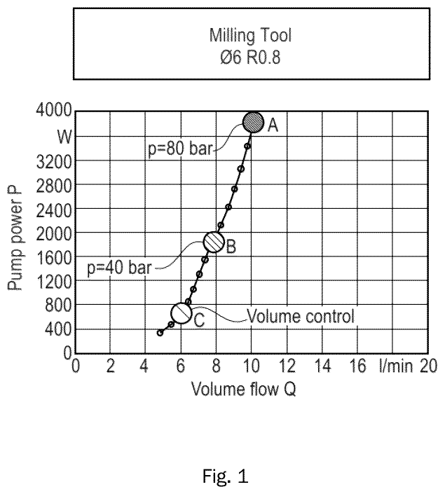

FIGS. 1 to 5 show exemplary pump characteristic curves for five different tools. After inserting the respectively shown tool, a pump for delivering a cooling lubricant CSS is operated at a plurality of performance characteristics and the resulting volume flow Q of the CSS through the tool is measured.

In FIGS. 1 to 5, the consumed power P of the pump in watts is plotted in each case against the volume flow Q in liters per minute. In each pump characteristic curve, three exemplary operating points are illustrated by large points. The upper point corresponds to a pressure control of the pump to 80 bar. The middle point corresponds to a pressure control of the pump to 40 bar. The lower point denotes in each case an optimum operating point for the volume control.

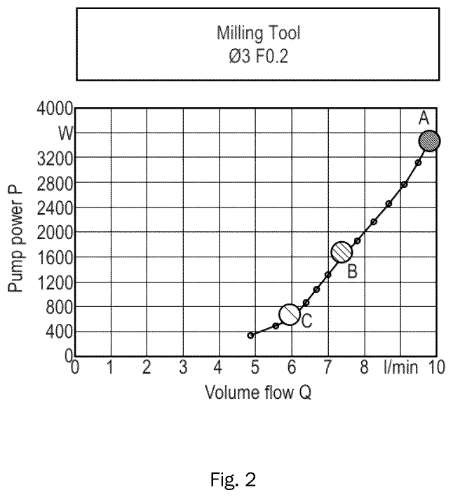

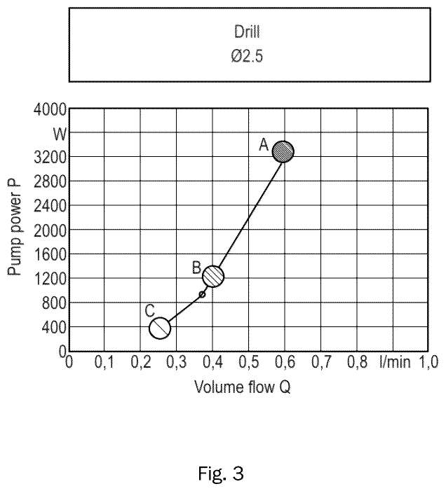

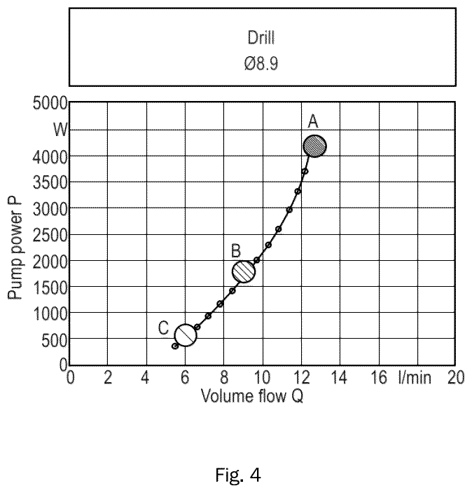

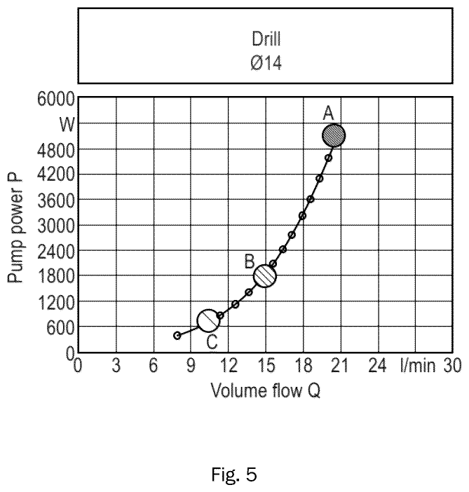

FIG. 1 shows, by way of example, the measured pump characteristic curve for a milling tool with a diameter of 6 mm (R0.8). FIG. 2 shows, by way of example, the measured pump characteristic curve for a milling tool with a diameter of 3 mm (F0.2). FIG. 3 shows, by way of example, the measured pump characteristic curve for a drill with a diameter of 2.5 mm. FIG. 4 shows, by way of example, the measured pump characteristic curve for a drill with a diameter of 8.9 mm. FIG. 5 shows, by way of example, the measured pump characteristic curve for a drill with a diameter of 14 mm.

The following table 1 provides an overview of the determined parameters at the optimum operating point of the pump with volume control in comparison with the conventional control to a pressure of 40 bar or of 80 bar for the exemplary tools shown in FIGS. 1 to 5. The values correspond in each case to the three points in FIGS. 1 to 5, wherein in each case the upper point corresponds to a pressure of 80 bar, the middle point corresponds to a pressure of 40 bar and the lower point corresponds to a volume control (see also labeling in FIG. 1).

TABLE 1

| | Volume Control | Pressure 40 bar | Pressure 80 bar |
|---|---|---|---|
| Tool | (point C) | (point B) | (point A) |
| Drill 14 mm | Q = 10 l/min | Q = 13 l/min | Q = 20 l/min |
| | P = 650 W | P = 1,850 W | P = 5,300 W |
| | p = 19 bar | | |
| Drill 8.9 mm | Q = 5.8 l/min | Q = 8 l/min | Q = 12 l/min |
| | P = 450 W | P = 1.400 W | P = 4.150 W |
| | p = 16 bar | | |
| Drill 2.5 mm | Q = 0.2 l/min | Q = 0.4 l/min | Q = 0.6 l/min |
| | P = 425 W | P = 1.400 W | P = 3.800 W |
| | p = 14 bar | | |
| Cutter 6 mm | Q = 5 l/min | Q = 6.5 l/min | Q = 9 l/min |
| | P = 600 W | P = 1.650 W | P = 4.800 W |
| | p = 9 bar | | |
| Cutter 3 mm | Q = 6 l/min | Q = 7 l/min | Q = 10 l/min |
| | P = 650 W | P = 1,300 W | P = 3,850 W |
| | p = 23 bar | | |

As can be read from the values of table 1, the suitable pump power P in the case of volume control is significantly reduced in comparison with the pressure control, a sufficiently large flow for cooling the respective tool still being achieved. The energy consumption can thus be significantly reduced. A lower pressure of the CSS can also provide a better surface quality of the machined workpiece and increase the service life of the tool. Furthermore, tests have shown that the service lives of tools with volume control could be increased by up to 26%.

Surprisingly, it has also been found that the surface quality or surface quality of the machined workpiece can also be significantly improved during cooling and lubrication of a tool with volume control. In summary, the following table 2 compares, by way of example, the surface quality of a workpiece which has been machined with a drill with a diameter of 10 mm at different pump power. Here, in each case at different power settings of the pump, a plurality of holes, in this case, for example, six holes, were drilled next to one another into the workpiece. The holes and the surface of the workpiece were then measured.

The measured variables or pump parameters are listed in the first column of table 2. Measurement was carried out at four different power settings of the pump. The results are illustrated in each case in the second to fifth columns of the table. The table entries indicate in each case how many of the six holes lie outside the respectively specified tolerance below them.

The fourth line of table 2 indicates in each case how many times the measured holes as a whole lie outside the tolerances greater than 10 μm. It should be noted here that one hole can violate a plurality of tolerance criteria at the same time.

The result shows that the volume control delivers an optimum result at a volume flow rate of 6 l/min. Here, the six holes were outside the tolerance only twice. In the case of the pump control to 80 bar which is conventional according to the prior art, the drilled six holes were, by contrast, 16 times outside the tolerance.

TABLE 2

| | | | | |
|---|---|---|---|---|
| Roundness 1 | all within the | 2x | 6x | 1x |
| | tolerance <10 | max. 12 μm | max. 18 μm | max. 14 μm |
| | μm | | | |
| Roundness 2 | 1x | 6x | 5x | 4x |
| | max. 7 μm | max. 18 μm | max. 19 μm | max. 21 μm |
| cylindrical | 1x | 6x | 5x | 4x |
| shape | max. 7 μm | max. 18 μm | max. 19 μm | max. 21 μm |
| outside the | 2x >10 μm | 14x >10 μm | 16x >10 μm | 9x >10 μm |
| tolerance | | | | |
| surface | R_{Max} = 5.86 | R_{Max} = 9.89 | R_{Max} = 14.5 | R_{Max} = 7.44 |
| roughness | | | | |
| pump power | 500 W | 1100 W | 3900 W | 350 W |
| volume flow | 6 l/min | 7 l/min | p = 80 bar | 5 l/min |

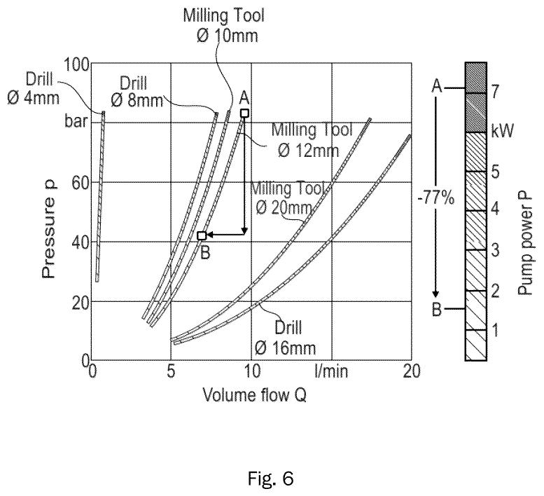

FIG. 6 has been taken from the article B. Denkena et al. “Energy efficient machine tools”, CIRP Annals—Manufacturing Technology 69 (2020) 646-667, wherein the English specifications have been translated. The article “Energy Efficient Machining with Optimized Coolant Lubrication Flow Rates” by B. Dekena et al., Procedia CIRP 24:25-31 is mentioned there as a source for the figure. FIG. 6 shows a comparison of pump characteristic curves of different tools.

In FIG. 6, the pump pressure p is plotted against the volume flow Q. In addition, the pump power corresponding to the pressure p is illustrated on the basis of the color of the curves. For the end mill with a diameter of 12 mm, the power reduction from the conventional pump pressure of 80 bar (point A) to 40 bar (point B) is illustrated by way of example, which is 77% here. The optimum operating point can even lie at an even lower pump pressure of approximately 20 bar.

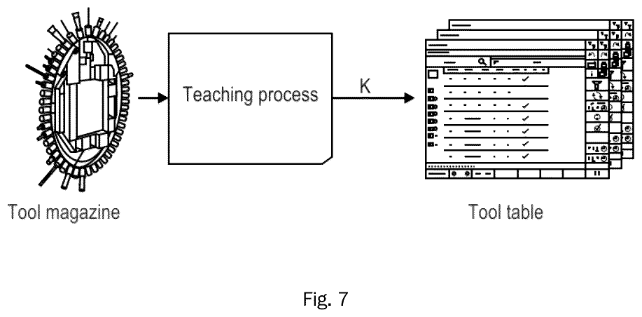

FIG. 7 shows the teaching process. FIG. 7 shows, on the left, a tool magazine with a plurality of different tools. For each tool of the tool magazine, the teaching process can be performed in order to determine the optimum operating point of the pump for the respective tool, which is then written into the tool table. In the example shown, the optimum operating point can be written into the tool table, for example, as a correction parameter K for the conventional operating point of, for example, 80 bar. This correction parameter K is preferably a dimensionless number which is less than 1 (e.g., the quotient of pressure at the optimum operating point and 80 bar).

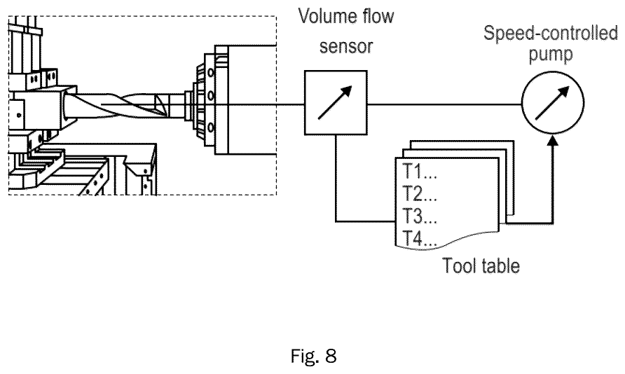

FIG. 8 shows a design for performing the teaching process and for determining the pump characteristic. A tool is clamped into the work spindle. A speed-controlled pump delivers the CSS for cooling the tool. A volume flow sensor which measures the volume flow Q is arranged in the flow path of the CSS. The pump controller successively sets a plurality of different pump parameters (or performance characteristics). The determined values can then be plotted as a pump characteristic and evaluated in order to determine the optimum operating point, which is then written into the tool table.

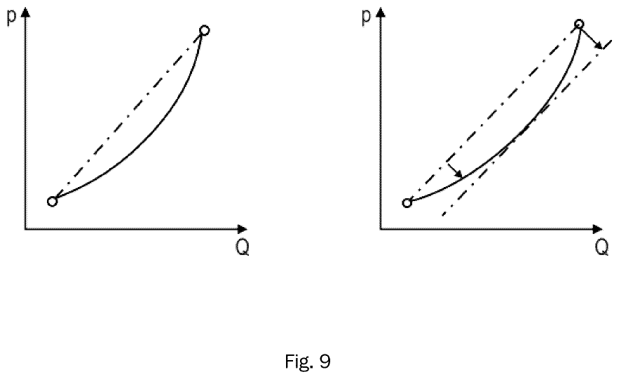

FIG. 9 shows an exemplary method for determining the optimum operating point. In the left-hand diagram of FIG. 9, an exemplary pump characteristic curve is plotted, wherein here the pump pressure p is plotted against the volume flow Q. A straight line is laid through the starting point and the end point of the characteristic curve. The slope of this straight line can be understood as a global relationship between pressure p and volume flow Q for the tool and is therefore a tool-specific parameter.

In a next step (diagram on the right in FIG. 9), the straight line is displaced in parallel until it touches the pump characteristic curve tangentially at a point. This touch point is defined as the optimum operating point for the tool and can be stored correspondingly in the tool table.

The exemplary method, described with reference to FIG. 9, for determining the optimum operating point from the pump characteristic curve can be stored and executed in particular as an algorithm in a control device of a machine tool or can also be executed by a computing device of a server or a cloud.

The features described above, in the claims, and in the drawings may be significant individually or in combination for implementing the disclosure in its various forms.

What is claimed is:

1. A method for operating a machine tool with a pump for delivering a cooling lubricant, the method comprising:
inserting a tool into a work spindle of the machine tool; and
performing a teaching process, further comprising:
determining a pump characteristic of the tool;
determining an optimum operating point of the pump for the tool; and
storing the optimum operating point of the tool in a tool table.

2. The method according to claim 1, wherein
the teaching process further comprises:
detecting a performance characteristic of the pump; and
detecting a volume flow of the cooling lubricant through the tool,
wherein the pump characteristic of the tool describes a dependence between the performance characteristic of the pump and the volume flow of the cooling lubricant through the tool.

3. The method according to claim 2, wherein
the teaching process is performed during idling of the machine tool without machining a workpiece and the pump is operated at a plurality of pressure settings.

4. The method according to claim 2, wherein
the teaching process is performed using data detected during machining of a workpiece.

5. The method according to claim 4, wherein
the teaching process is performed using data of a plurality of machine tools.

6. The method according to claim 1, wherein
the optimum operating point is determined depending on a type of the tool.

7. The method according to claim 4, wherein
the optimum operating point is determined depending on a type of the tool and/or depending on a material of the workpiece.

8. The method according to claim 1, wherein
the optimum operating point is determined by executing an algorithm.

9. A method for machining a workpiece with a machine tool having a pump for delivering a cooling lubricant, the method comprising:
inserting a tool into a work spindle of the machine tool;
detecting an optimum operating point of the pump depending on the inserted tool; or
detecting an optimum operating point of the pump depending on the inserted tool and a material of the workpiece; and
machining the workpiece, wherein the pump is operated at the optimum operating point.

10. A machine tool for machining a workpiece, comprising:
a work spindle for receiving a tool for machining the workpiece;
a pump for delivering a cooling lubricant for cooling the tool; and
a control device for numerically controlling the machine tool, wherein the control device is configured to carry out a method according to claim 1.
